(19) United States
(12) Patent Application Publication
(10) Pub. No.: US 2012/0093441 A1
(43) Pub. Date: Apr. 19, 2012

(54) Bag with handle and method of manufacture thereof

(76) Inventors: Brian George Hutchison, Brampton (CA); Michael Reid Martin, Toronto (CA)

(21) Appl. No.: 13/337,027

(22) Filed: Dec. 23, 2011

Related U.S. Application Data
(63) Continuation-in-part of application No. 12/202,502, filed on Sep. 2, 2008.

(51) Int. Cl. B65D 33/06; B31B 1/86

(52) U.S. Cl. 383/17; 493/226

(57) ABSTRACT

A bag includes a panel having an inner surface and an outer surface and an elongate aperture through the panel. A handle strip having a handle carrying part is disposed adjacent the panel inner surface with the carrying part inserted through the aperture. Extension parts of the handle strip depending from the carrying part are located adjacent the panel inner surface and one or both of the extension parts are folded over and heat sealed to each other and to the inner surface of the bag. The folded extension acts to provide a reinforcing strip and to seal the aperture.

### RELATED APPLICATIONS

This application claims priority under 35 USC §120 as a continuation in part of the co-pending application entitled, BAG WITH HANDLE AND METHOD OF MANUFACTURE THEREOF, having Ser. No. 12/202,502, filed on Sep. 2, 2008.

### TECHNICAL FIELD OF THE INVENTION

The present invention relates to a bag having a carrying handle and extends to a method of manufacturing such a bag. The invention has particular application to plastic bags.

### DESCRIPTION OF RELATED ART

Plastic bags are a ubiquitous and highly practical mode of carrying things and there is a whole panoply of shapes and structures of such bags depending on the particular function of the bag. Many bags have handles of some kind or other. These may be merely formations in the material of the bag or may include additional elements which are attached to the main carcass of the bag and which provide added strength and convenience.

United States published patent application 20060188178 describes a packaging container made of plastic film having a strap handle fixed into the container wall. The container wall has an inner side and the strap handle is arranged on the inner side. The container wall has an access opening through which the strap handle is accessible from the exterior of the container. A support patch made of plastic film is connected to the container wall and closes off the access opening relative to the interior of the container. United States published patent application 20090022430 to which this application is a continuation-in-part describes a bag made of plastic film having a strap handle fixed to the container wall. The strap handle has respective end parts which during manufacture are threaded into spaced apertures in the container wall. The end parts are folded over and heat sealed to an inside surface of the container wall.

While these arrangements have value, further improvements are possible to improve the performance and simplicity of manufacture of bags having associated handles. Limitations and disadvantages of conventional and traditional approaches to bag-with-handle designs and their manufacture will become apparent to one of ordinary skill in the art through comparison of such bag and handle arrangements with the present invention.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIGS. 1-3 show front and side views of a pouch bag according to an embodiment of the invention.

FIG. 4 is a perspective view from above of one form of handle piece for use in a handled bag according to an embodiment of the invention.

FIG. 5 is a perspective view from above of another form of handle piece for use in a handled bag according to an embodiment of the invention.

FIG. 6 is a perspective view from above of a further form of handle piece for use in a handled bag according to an embodiment of the invention.

FIG. 7 is a perspective view from above of a further form of handle piece for use in a handled bag according to an embodiment of the invention.

FIG. 8 shows part of a continuous web of thermoplastics film used in the manufacture of a handled bag according to an embodiment of the invention.

FIG. 9 is a perspective view from above showing part of the outside face of a gusset panel with a handle piece attached according to an embodiment of the invention.

FIG. 10 is a perspective view from above showing part of the inside face of the gusset panel at an intermediate stage of attaching the handle piece according to an embodiment of the invention.

FIG. 11 is a perspective view corresponding to FIG. 10, but showing the gusset panel at a subsequent manufacturing stage.

FIG. 12 is a perspective view corresponding to FIG. 11, but showing the use of a handle piece such as that shown in FIG. 4 or 5.

FIG. 13 is a plan view corresponding to the view of FIG. 11, but showing the gusset panel from the exterior of the bag and illustrating the position of heat sealing regions according to an embodiment of the invention.

FIG. 14 is an exploded perspective view showing part of a panel and a handle piece being brought to the panel in the course of manufacturing a bag according to an embodiment of the invention.

FIG. 15 is a longitudinal sectional view on the line B-B of FIG. 14.

### DETAILED DESCRIPTION OF THE INVENTION INCLUDING THE PRESENTLY

### Preferred Embodiments

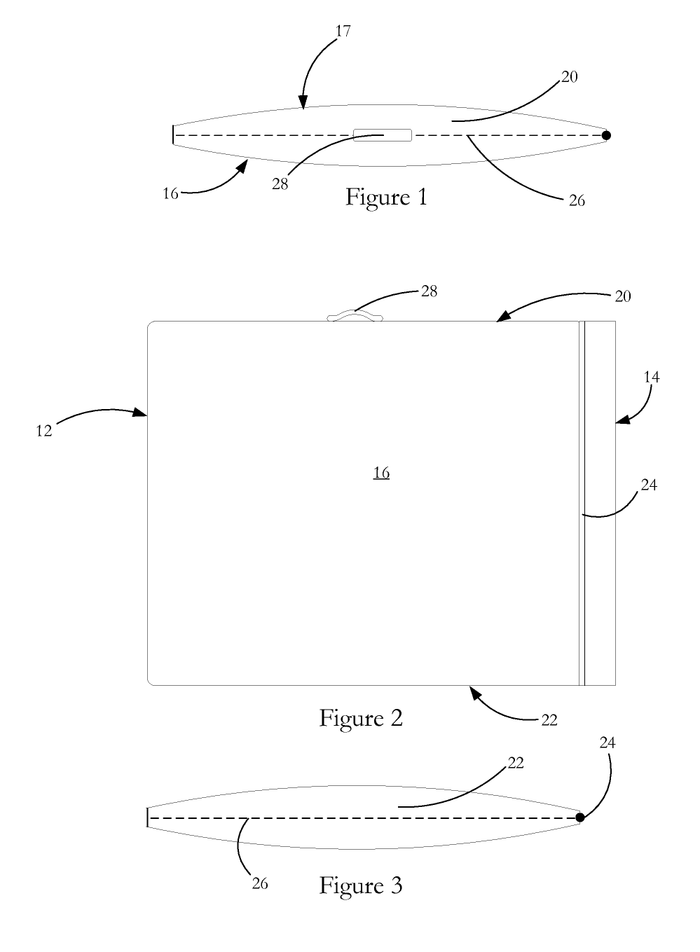

Referring to FIGS. 1 to 3, a bag according to one embodiment of the invention is of a pouch form having opposed ends 12, 14, front and back panels 16, 17, and opposed side panels 20, 22. The end 14 of the bag has a press-to-close zipper arrangement 24 which enables opening and closing of the end 14, although the end 14 can alternatively be sealed during manufacture if the bag is to be filled from the end 12. The press-to-close zipper arrangement 24 can alternatively be another form of closure such as a slider zipper arrangement. The end 12 is left open to allow for later filling and then sealing, or is sealed off during manufacture if the bag is to be filled from the end 14. The side panels 20, 22 each provide a gusset region by being folded along their length as shown at 26. It will be understood that the pouch bag is just one form of bag structure in which the invention can be embodied. Bags having other shapes, closures, folds, reinforcements, gussets, materials, etc., can all use the principles of the invention. The side panel 20 has a handle 28 attached to it to allow the bag to be carried in one hand like a briefcase or suitcase.

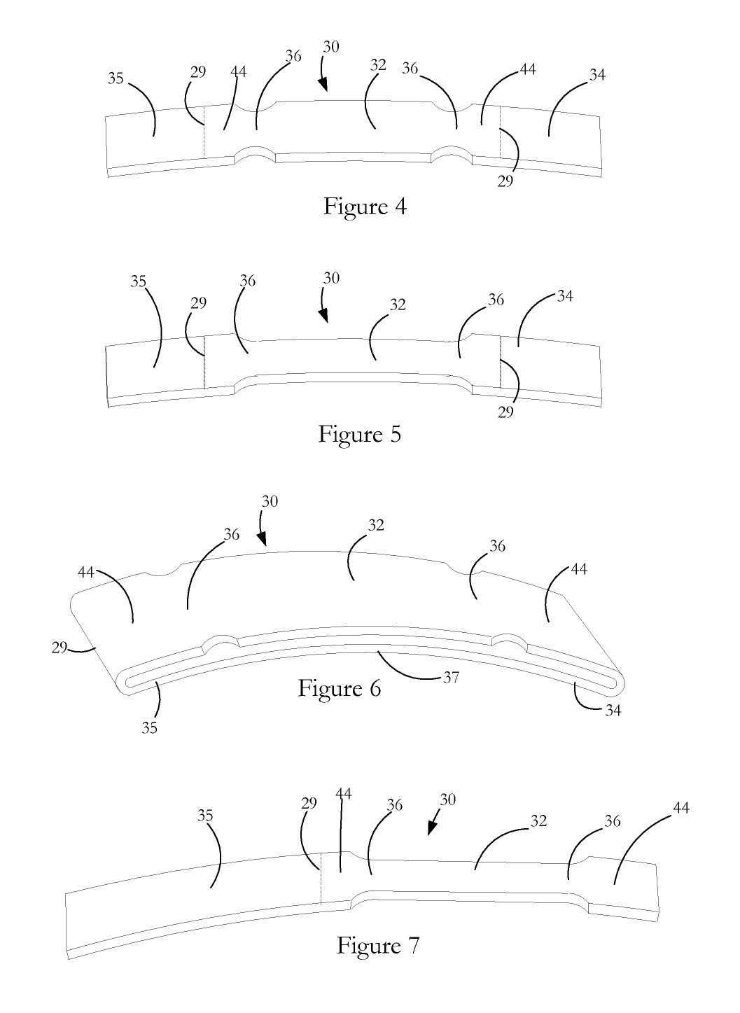

A handle piece 30 suitable for use in making a handled bag according to one aspect of the invention is shown in FIG. 4. The piece is formed as a strip of thermoplastics film material and has a central part 32, which is intended to be gripped by a person carrying the bag when the strip is assembled as part of a handled bag. On either side of the central part are regions 36 of reduced width, and sections 44 extending between the regions 36 and respective fold lines 29. The handle strip has outer parts 34, 35 extending to the strip ends. As shown in FIG. 4, the central carrying part 32 is of the same width as the outer parts 34, 35. As shown in FIG. 5, an alternative form of handle piece has a central carrying part 32 that is relatively narrower than the outer strip parts 34, 35. The carrying part extends between and is the same width as the reduced width parts 36. A further alternative handle piece 30 as shown in FIG. 6 is formed as a continuous loop which can be considered to be essentially the same as the FIG. 4 handle piece, but with the outer parts 34, 35 folded under the sections 44 and joined as a single linking span 37. Another alternative handle piece 30, as shown in FIG. 7, has a long outer part 35 at one end but no outer part 34. The FIG. 7 handle piece, like the FIG. 5 piece, has a carrying part 32 of reduced width.

The various forms of handle piece 30 are intended to be assembled with a web of thermoplastic film material to form the complete bag, although it will be realized that the principles of the invention can be employed with a bag formed from multiple web pieces. The manner in which the handle piece cooperates with related parts of the bag is best illustrated by the following description of part of the bag manufacture according to one exemplary embodiment.

In such a manufacturing process, a web of thermoplastic film material is unrolled from a stock roll and is driven around rollers through a plurality of stations in which any of a number of operations is performed. These can include any or all of (a) folding, (b) cutting, (c) punching, (d) forming or adding gusset pieces, (e) forming or adding reinforcing areas, (f) application of adhesive (g) heat sealing, (h) cooling, (i) fitting elements of a press-to-close or other fastener, etc. It will be understood that the pouch bag is just one form of bag to which the invention is applicable and that bags having other shapes, panels, closures, gussets, materials, etc., can be manufactured using the method of the invention with appropriate modifications depending on the particular form of bag being made.

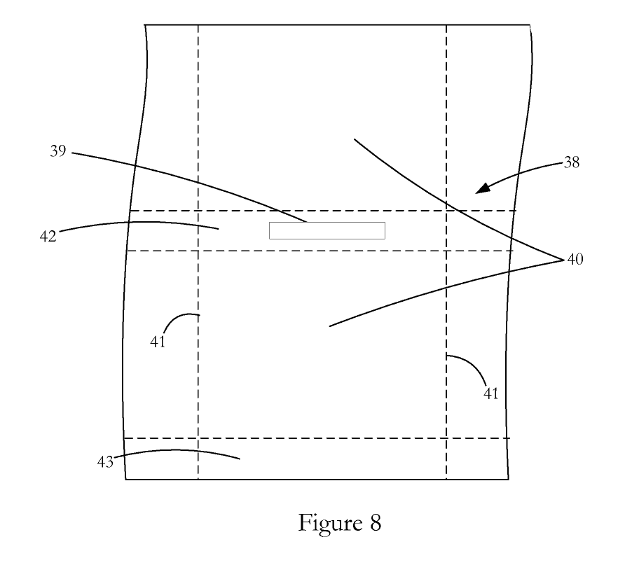

FIG. 8 illustrates part of a continuous web 38 suitable for forming a pouch bag of the form shown in FIGS. 1 to 3. Lines 41 show divisions between regions of the web 38 which are to be formed into separate bags. The web has areas 40 which are to become the bag front and back panels, and areas 42, 43 which are to become, respectively, top and bottom gusset panels of the bag. During the course of manufacture, the web is driven through a punching station where it is halted momentarily and a slot-form hole 39 is punched in the area 42 that is to become the top gusset panel.

To form the handle pieces, a continuous web of handle piece material is also unrolled from a stock roll and is used to form a series of handle pieces with successive strips being delivered to successive holes 39. The handle piece web is driven around rollers to a punching station at which cut-outs are punched from the web to form the reduced thickness regions 36 and, where applicable, the narrower carrying part 32. The bag web and the handle piece web are then fed to an assembly station where the webs are momentarily halted to allow a handle piece 30 to be separated from the handle piece web and to be attached to the bag web 38.

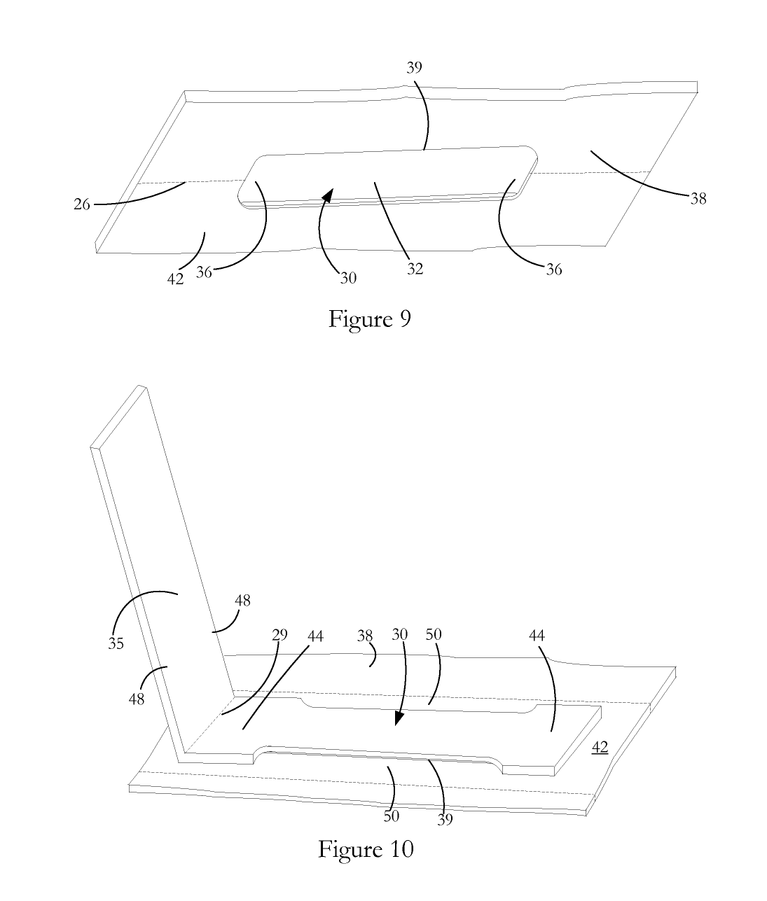

Referring to FIG. 9, and having reference to the handle piece 30 of FIG. 7, the separated handle piece is delivered from above the web 38 on a transfer head, the handle piece being maintained in position during its transfer by a vacuum means. The head is driven to a position in which the carrying part 32 is in registration with the hole 39. The lower side of the web 38 is to face outwardly in the finished bag to expose the handle carrying part 32 for gripping by the user, while the upper side is to face inwardly. It will be appreciated however that the disposition of the web and the handle piece can be reversed with the handle piece being delivered from below. The length of the reduced width carrying part 32 is substantially equal to the length of the hole 39 and has a width substantially equal to the width of the hole 39 at the hole ends. The width relationship assists in enabling a strong anchoring seal where the handle is fixed to the bag panel as will be described presently.

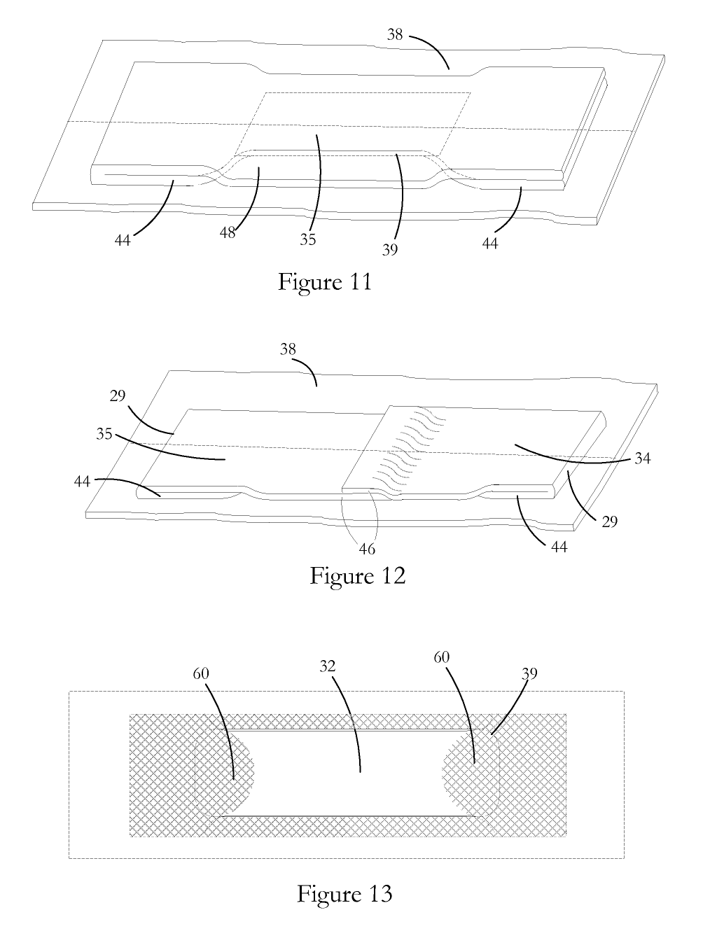

With reference to FIG. 10, which shows part of the panel 42 from above, the bag web 38 with the handle piece 30 in place is subjected to a first heat sealing step during which the parts 44 are tack sealed to the bag web 38. The tack seal serves to fix the bag web and the handle piece in a proper disposition for subsequent processing and also initiates a folding action to create the fold line 29 in the part 35. In a subsequent heat sealing step, the part 35 is fully folded by a retractable plate arrangement and held against parts 44 and parts of the web 38. As shown in FIG. 11, the folded over part 35 is heat sealed against the underlying parts 44 to form double thickness reinforcing zones which are also heat sealed to the web surface. As part of this heat sealing operation, the marginal side edges 48 of the part 35 are sealed to marginal side edges 50 (FIG. 10) at the hole 39. This heat sealing is applied at targeted regions chosen to provide strengthened regions where the carrying part is anchored to the bag panel, and to ensure isolation of the bag interior from its exterior when the bag is fully assembled. A two-part heat sealing operation with ambient or accelerated cooling is used to create a strong bond and to limit heat build-up which might otherwise cause degradation of the thermoplastics material.

Suitable regions for heat sealing are shown as cross-hatched areas in the plan view of FIG. 13. The heat sealing regions follow the sides of the hole 39, but at each end of the handle piece, intrude into the area occupied by the ends of the carrying part 32 as shown at regions 60. This disposition is selected to ensure that the major weight components are directed towards and borne by the multi-thickness reinforcing zones rather than having such weight components applied directly to an unreinforced part of the bag panel. It will be appreciated, however, that other shapes and locations can be chosen for the heat sealing regions depending on where a seal is desired, strength requirements, etc. The seal regions can provide hermetic sealing as between the upper and lower side of the web at the handle zone, this being important if the assembled bag is to carry foodstuffs or the like. Of some advantage in the assembly process is that the attachment and sealing of the handle takes place on the side of the web opposite to that to which display graphics related to the identity of bag contents, instructions, etc., will normally have been previously been applied.

Returning to FIG. 11, the arrangement is such that the part 35, where it is folded on itself and where it is folded onto the parts 44, provides double thickness reinforced regions of the handle piece film material where the handle piece is sealed against the inner surface of the gusset panel 20. The folded over part 35 also acts to seal the hole 39 against entry of contaminants from the exterior of the bag and from escape of contents from the interior of the bag, these being formed as a hermetic seal which is particularly important if, the bag is to carry foodstuffs. For this reason, a handle piece profile must be such that, upon assembly, it presents an area of overlap at or near the edges of the hole 39. If sealing is not important, then the handle can be attached to the bag in a non-sealing arrangement, provided that the strength of the handle anchor region is not unduly compromised.

Bags using the handle pieces of FIGS. 4, 5 and 6 can be made using process steps which are similar to the process steps described above with respect to the handle piece of FIG. 7, but tailored, as will be understood by those skilled in the art, to the particular design of bag and handle arrangement. For illustration purposes, a section of gusset panel in which the FIG. 5 handle piece is used is shown in FIG. 12. In the handle piece attachment, both the outer strip parts 34 and 35 are folded about the fold lines 29 and are heat sealed with their ends overlapping as shown at 46.

In a further embodiment (not shown) a handle piece of the loop form shown in FIG. 6 or a handle piece in which the outer strip parts 34, 35 have been folded over and tack sealed in position is prepared before being brought to the position in which it is to be attached to the web. The separate preparation of the handle piece into a folded or loop form means that the folding actions do not need to be effected at the web 38. The prior formation of the handles is of particular advantage when making small bags where the web handling machinery may not offer the space required for a folding operation.

The embodiments of the invention illustrated and described all relate to a bag in which the panel to which the handle is attached also functions as a gusset. It will be understood, however, that the handle can be attached to any panel of the bag. It will be appreciated that many variations are possible in the design of a bag and handle arrangement using the principles of the invention. For example, a slot form is used for the hole 39 to match the rectangular form of the handle piece carrying part. However, other shapes can be utilized depending on the properties required at the joints between the handle piece carrying part and the reinforcing regions, and also, the relationship of the joint regions with adjacent regions of the bag panel. Thus, the hole can be of an oval or slit form.

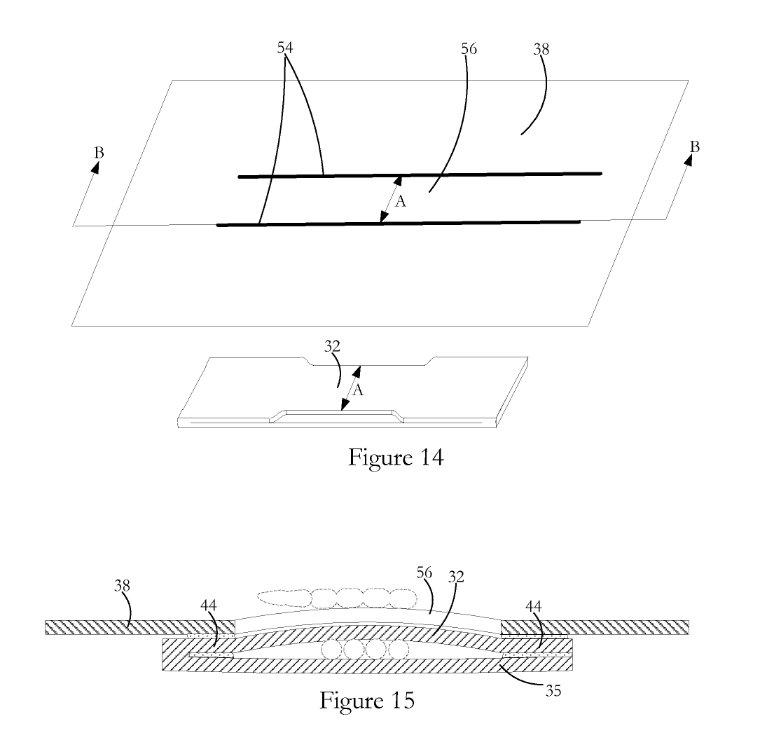

In a further embodiment, the hole is formed as a pair of parallel slits 54 as shown in the exploded view of FIG. 14. The spacing A and length of the slits correspond to the width and length of handle carrying part 32. Consequently, when the handle piece is brought to the web 38 to be sealed in position, the carrying part 32 underlies a part 56 of the gusset panel extending between the two slits 54. This has the advantage that any graphics printed on the outside of the bag (i.e. the upper surface of the web 38 as represented in FIGS. 14 and 15) is not interrupted by the handle carrying part 32. In use as represented in FIG. 15, the bag is carried by the user pushing his or her fingers down at the slits to grip both the top region 56 and the carrying part 32 of the underlying handle piece. Heat sealing can be applied at the region 56 to add strength and to aid in the region 56 and the underlying carrying part 32 being manipulated as a single handle unit by the bag user.

In using a handled bag having the structure described, the user hooks his or her fingers under the handle part and lifts. The weight of the bag is suspended from the handle and from anchor zones where the reinforcing strips created by the folded or overlapping handle piece portions are sealed to the gusset panel. As the user carries the bag, his or her knuckles face the folded elements of the handle piece which close off the hole 39 and underlie the handle carrying part. A handled bag having the structure described is particularly convenient for carrying as it presents a single handle for carrying rather than a pair of handles that must be brought together and lifted together in order to enable the bag to be carried in a balanced fashion. A substantial component of stress when the bag is carried is a normal stress acting generally perpendicular to the plane of the reinforcing strip and the panel. The handle piece, although flexible and therefore deforming in use, has an initial planar aspect which is generally normal to the weight direction. This means that the carrying part is relatively comfortable for holding in that forces on the hand are distributed and have reduced tendency to cut into the hand compared to a material being carried edge-on. In this respect, the area of the carrying part can be made larger as required depending on the weight to be carried and the carrying comfort desired. The initial aspect of the reinforcing strips is also generally normal to the weight direction which means that a substantial component of stress when the bag is carried is a normal stress, although as the material of the handle strip and the bag panel deform during carrying, another component of carrying stress will be a shear stress. The strength of the anchor zones at the end of the handle carrying part can be altered as required by altering the area of the reinforcing strips where they are sealed to the panel.

In each of the embodiments of the invention described, the bag, the handle piece and the reinforcing strip are formed from heat-sealable thermoplastics film materials and sealing is effected by heat sealing. Such materials include, by way of example and not limitation, polyolefins such as polyethylene and polypropylene, polyesters, vinyl polymers, and the like. The film materials may be of low-, medium- or high-density polymer composition and may be single or multi-layer composite materials. Composite laminated materials may include adhesive layers. Suitable materials for adhesive or tie layers are adhesive resins such as Mitsui Petrochemical's ADMER®. Sealing resins such as ethylene vinyl acetate may be used to improve sealing of certain polymer layers and the use of such sealing resins may obviate the use of adhesive tie layers. The invention contemplates the use of thermoplastics films which are made of, or which include, a barrier sheet material such as, for example, EVOH which provides a barrier generally preventing the transmission of gases. The thickness of the film material of the web is selected mainly on the basis of the intended weight the bag must carry and generally ranges from about 2 to 20 mils. The strip material can be different from the web material provided that the materials are rendered compatible for heat sealing at the locations where heat sealing takes place.

While thermoplastics film is preferred as a construction material, the invention is also applicable to bags formed of other sheet materials such as stiff paper or card and to other sheet or foil materials. The type of thermoplastics or other sheet material used depends on the purposes to which the bag is to be put, whether it is easy to handle in manufacturing, whether it can be readily printed upon, whether it is waterproof, whether it is strong enough to resist tearing or bulging, etc.

In one example, the film material of the handle piece and the reinforcing strip are formed from two layers of a composite sheet of coextruded, alternating layers of thermoplastics and adhesive in the following order: 1.75-1.9 mils polyethylene, 0.35-0.5 mils adhesive polymer, 0.5 mils nylon, 0.35-0.5 mils adhesive polymer, 1.75-1.9 mils polyethylene. This composite sheet can be bought from a number of extrusion companies, including Berry Plastics Corporation. The handle can be made by laminating together two layers of the composite sheet described above using an adhesive that may be solvent based or solvent-less (i.e. 100% solids). The strips can be formed from other film material depending on the particular properties required of the handle and the reinforcement from the viewpoint of the bag function and its manufacturability. An alternative composite structure thermoplastics has a multi-ply layered material with outer layers of polyethylene and a core layer of nylon. The particular selection of ply materials and the number of layers of each material is chosen for the particular properties desired in the bag. Thus, polyethylene has good heat sealing properties and relatively high strength. A copolymer polyethylene with high plastomer content can be used where a soft handle is required. The material of both the handle piece and the reinforcing strip is selected to achieve required reinforcing action where the handle piece is anchored to a bag panel. For example, thermoplastic films can be used which have been oriented during manufacture to impart particular mechanical strength along the line of the handle or at other critical stress sites. Such oriented strength can be imparted, as is known, by for example stretching at ambient temperatures, melt orienting during extrusion, etc.

Heat sealing and bonding of layers of sheet material is effected by the application of temperature and pressure for a predetermined time at locations where the layers are to be heat sealed. The particular temperature, pressure and time are selected based on the particular nature of the sheet materials being bonded together. Bonding is typically effected at multiple bonding stations, with the bonded material subsequently being cooled. For materials such as stiff paper or card which cannot be heat sealed, an adhesive is used at the contact zones between the handle piece and the reinforcing strip, with adhesive being used also where the reinforcing strip and the handle piece, other than the handle part, contact the surfaces of the panel within which the handle is anchored.

In the heat sealing operation, the heat sealing zone is made to extend over the full area of the folded material so that no part of the folded material is free. Any free or unsupported part of the handle piece or reinforcing strip material is undesirable because it can be a source of weakness and a source of air and contaminant entry. It can also contribute to an overly bulky material which is undesirable especially if at a later stage of bag formation, the panel containing the handle is to be folded to form a gusset area.

It is important in all bonding operations, whether by heat sealing or adhesive, to avoid channel leaks since these can be a source of entry of insects, air and moisture which can later attack and adulterate the contents of the bag if the contents are edible materials such as pet food. One source of channel leaks is wrinkling of the materials being bonded. In the case of thermoplastics, wrinkling and channel leaks are minimized by ensuring that a thermoplastics material is used which has good heat flow properties. For example, high heat flow can be obtained by increasing the plastomer polyethylene content of a polyethylene layer, the regular polyethylene and plastomer polyethylene forming a tailored co-polymer. However, the plastomer content is not made so high as to adversely affect the machinability of the finish material or to render it unpleasantly tacky. A suitable percentage of plastomer polyethylene is typically from 20 to 25%.

Other variations and modifications will be apparent to those skilled in the art. The embodiments of the invention described and illustrated are not intended to be limiting. The principles of the invention contemplate many alternatives having advantages and properties evident in the exemplary embodiments.

What is claimed is:

1. A bag having a panel, the panel having an inner surface and an outer surface and an aperture through the panel, an elongate handle piece adjacent the panel inner surface, the handle piece having a carrying part accessible from the outer surface through the aperture, and extensions contiguous with the carrying part at respective ends thereof, at least one of the extensions having a first portion and a second portion, with the second portion folded onto and sealed against the first portion to form at least one reinforcing strip disposed adjacent to and sealed to the inner surface of the panel to anchor the handle piece to the panel.

2. A bag as claimed in claim 1, the handle piece formed of a thermoplastics material, the first and second portions of the at least one extension sealed together by heat sealing.

3. A bag as claimed in claim 1, each of the extensions having a first portion and a second portion, with the second portion of each extension folded onto and sealed against the first portion of such extension to form a pair of reinforcing strips disposed adjacent to and sealed to the inner surface of the panel.

4. A bag as claimed in claim 3, wherein ends of the respective second portions overlap and are sealed to one another.

5. A bag as claimed in claim 1, wherein one of the extensions has a first portion and a second portion, with the second portion folded onto and sealed against the first portion to form a first reinforcing strip, said one extension being longer than the other extension and having an end portion contacting and sealed against the other extension to form a second reinforcing strip, said reinforcing strips adjacent to and sealed to the inner surface of the panel.

6. A bag as claimed in claim 1, the bag having a pair of such reinforcing strips located at each end of the carrying part to anchor the carrying part to the panel.

7. A bag as claimed in claim 1, one of the extensions being integral with, and contiguous with, the other extension, whereby the handle piece is in the form of a loop.

8. A bag as claimed in claim 1, the at least one reinforcing strip fully closing and sealing the aperture.

9. A bag as claimed in claim 1, the handle piece formed of a composite, layered material including a polyethylene-nylon-polyethylene sandwich structure.

10. A bag as claimed in claim 1, the aperture formed as a slot form hole, the handle piece having parts of reduced width at the ends of the carrying part, the reduced width parts seating at respective locations of the hole where the width of the hole is substantially the same as the width of the reduced width portions.

11. A bag as claimed in claim 1, the aperture formed as two generally parallel slits, the handle piece having parts of reduced width at the ends of the carrying part, the reduced width parts seating at respective locations of the parallel slit aperture where the spacing of the slits is substantially the same as the width of the reduced width portions.

12. A bag as claimed in claim 11, the carrying part extending between the reduced width parts being itself of reduced width.

13. A bag as claimed in claim 11, a region of the panel between the slits overlaying at least a part of the carrying part.

14. A bag as claimed in claim 13, the overlaying region and the said part of the carrying part sealed together.

15. A bag as claimed in claim 1, further comprising a heat sealing zone at the ends of the hole which intrudes into areas occupied by the ends of the carrying part.

16. A bag as claimed in claim 1, the panel being an upwardly facing panel when the bag is in a carrying aspect.

17. A bag as claimed in claim 16, wherein a substantial component of stress when the bag is carried is a normal stress acting generally perpendicular to the plane of the at least one reinforcing strip and the panel.

18. A bag as claimed in claim 1, the handle piece anchored to the panel at a position generally central of the panel.

19. A bag as claimed in claim 1, the panel being a gusset panel.

20. A method of making a handled bag, the bag having a panel with an inner surface and an outer surface and an aperture through the panel, the method comprising bringing an elongate handle piece to a position adjacent the panel inner surface so that a carrying part of the handle piece is accessible from the outer surface through the aperture, and folding at least one extension of a pair of extensions contiguous with the carrying part at respective ends thereof so that a first portion of said extension is folded onto a second portion thereof, and heat sealing to seal the first portion to the second portion to form at least one reinforcing strip disposed adjacent to and to seal the at least one reinforcing strip to the inner surface of the panel to anchor the handle piece to the panel.
